(19) United States
(12) Patent Application Publication
(10) Pub. No.: US 2004/0069939 A1
(43) Pub. Date: Apr. 15, 2004

(54) Phantom power optical microphone system

(75) Inventors: Alexander Paritsky, Modiin (IL); Sergei Smirnov, Yehud (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Phone-Or Ltd., Or-Yehuda (IL)

(21) Appl. No.: 10/268,326

(22) Filed: Oct. 10, 2002

(51) Int. Cl. G01D 5/34

(52) U.S. Cl. 250/231.1

(57) ABSTRACT

The invention provides a noise suppression phantom power optical microphone system having an optical microphone consisting of a light source having an input terminal, a membrane and a photodetector having an output terminal, the system including a signal amplifier connectable to the output terminal of the photodetector; a processing amplifier connected to the output of the signal amplifier for providing high amplification to relatively weak input signals and low amplification to relatively strong input signals; a first circuit connecting the input terminal of the light source to a phantom power source; a second circuit connecting the output of the signal amplifier to the first circuit, and a third circuit connecting the output of the processing amplifier to the first circuit.

### FIELD OF THE INVENTION

The present invention relates to phantom power optical microphone systems, and more particularly, to optical microphones having noise suppression systems operating on the principles of phantom power sources.

### BACKGROUND OF THE INVENTION

A phantom power optical microphone is an optical microphone that receives its power supply from the leakage current of the circuit to which the microphone is connected. Phantom power optical microphones are wide-range optical microphones having very low energy consumption, such as optical microphones used for cellular telephones and the like.

U.S. Pat. No. 6,091,497 discloses several types of fiber optic and optical microphone/sensors that possess the ability to sense sounds by means of light energy. The patent describes the main, basic principles and construction of such microphones. These, and other known microphone/sensors, require a relatively large amount of power, have specific load characteristics, and are not intended to operate with phantom power supply, which is very small, sometimes less than half a milli-Watt.

In contradistinction to the known optical microphones that cannot be used in phantom power systems, the noise suppression phantom power optical microphones according to the present invention are intended to operate at a very low power consumption, depending on the power load, overcoming the deficiencies of known optical microphones, and may be used in any cellular telephone system.

### DISCLOSURE OF THE INVENTION

It is therefore a broad object of the present invention to provide a noise suppression phantom power optical microphone that may be successfully used in any cellular telephone system, requires very little energy, and provides high suppression of any kind of ordinary and random acoustical, and other, noise.

The invention therefore provides a noise suppression phantom power optical microphone system having an optical microphone consisting of a light source having an input terminal, a membrane and a photodetector having an output terminal, the system comprising a signal amplifier connectable to the output terminal of the photodetector; a processing amplifier connected to the output of the signal amplifier for providing high amplification to relatively weak input signals and low amplification to relatively strong input signals; a first circuit connecting the input terminal of the light source to a phantom power source; a second circuit connecting the output of the signal amplifier to the first circuit, and a third circuit connecting the output of the processing amplifier to the first circuit.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a circuit diagram of a first embodiment of a noise suppression phantom power optical microphone system according to the present invention; and

FIGS. 2-9 are circuit diagrams of several embodiments of the system according to the invention.

### DETAILED DESCRIPTION

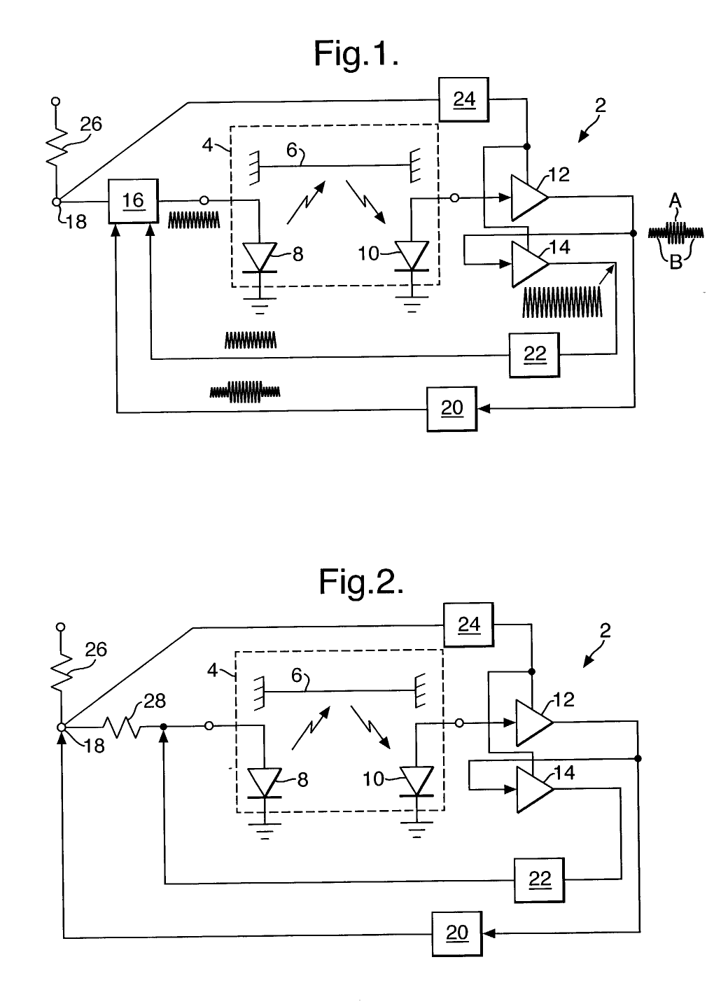

Referring now to FIG. 1, there is illustrated a circuit diagram of a noise suppression phantom power optical microphone system 2, consisting of a per-se known housing 4, a membrane 6, a light source 8 and a photodetector 10. The output from the photodetector leads to a signal amplifier 12 and, in turn, to a processing amplifier 14. The light source 8 is fed by a circuit 16 having an output terminal 18. The output from amplifier 12 leads through a circuit 20 to the input circuit 16; similarly, the output from processing amplifier 14 leads through a circuit 22 to the same input circuit 16. Output terminal 18 is connected, via a filter circuit 24, to both amplifiers 12 and 14.

The output of terminal 18 of the optical microphone system 2 (input to circuit 16) is the point where the optical microphone obtains power for the entire system, and also comprises the leakage current of the circuit, shown by dashed lines in FIG. 1 as resistor input 26.

The nature of circuits 16, 20, 22 and 24 will be described below with reference to FIGS. 2-9.

As can be understood, a very small leakage current, e.g., about 0.1-0.2 mA, that is present at the input of circuit 16 (resistor input 26) is fed to light source 8, which produces a light beam directed to and reflected by membrane 6, to be detected by photodetector 10. Due to acoustical pressures, membrane 6 changes its position and causes changes in the reflected light intensity which is detected by photodetector 10. The output voltage of photodetector 10 is amplified by the signal amplifier 12. The output signal of amplifier 12, composed of relatively large, useful signals A and small noise signals B, passes through circuit 20 and, in turn, through circuit 16 to the input of a circuit to which it is connectable (resistor input 26). Circuit 20 is used for filtering and impedance matching, if required, of the output signal of amplifier 12 with the circuit 16, to which it is attached. Amplifier 14 is used for analog processing of measured acoustical signals and for suppression of acoustical and other noises. Circuit 22 is used for filtering and impedance matching of processed signals emitted from amplifier 14 with the light source 8, through circuit 16.

A possible modification of phantom power optical microphone system 2 is shown in FIG. 2, in which circuit 16 is shown to be composed of one or more resistors 28. In this embodiment, the output of circuit 20 is connected directly to the input of terminal 18 and resistor input 26, and the output of circuit 22 is connected directly to the light source 8.

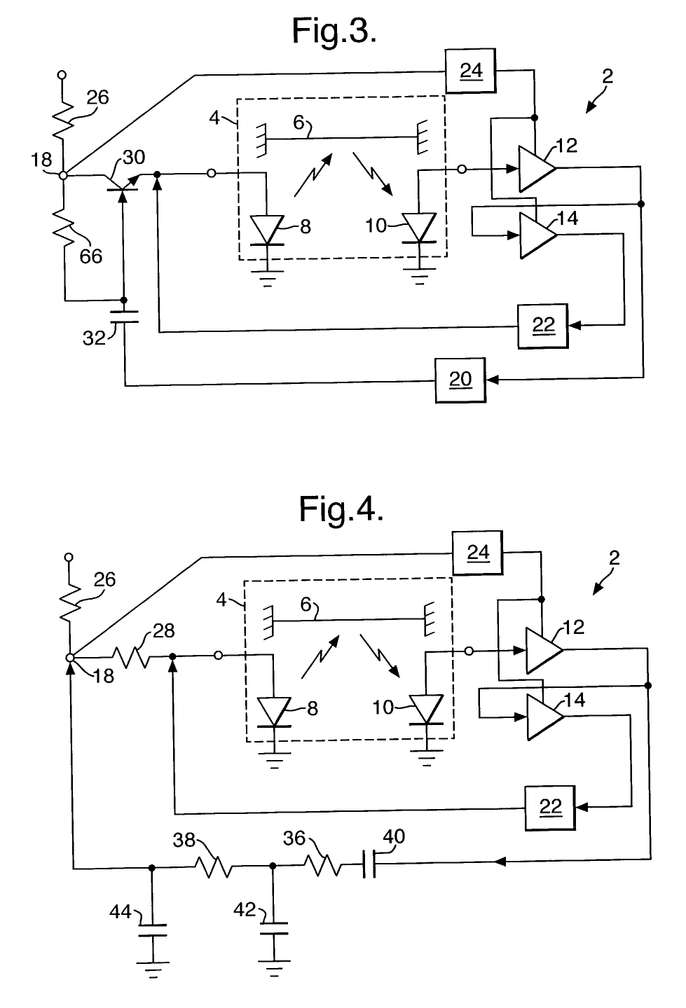

A further possible embodiment of a phantom power optical microphone system 2 is shown in FIG. 3, wherein circuit 16 is constituted by a transistor 30. Accordingly, the output of circuit 20 is connected through capacitor 32 to the base of transistor 30, which amplifies the output signal of amplifier 12 if the resistor input 26 requires an increase in input signal power.

FIG. 4 illustrates details of circuit 20, for matching and filtering the output signal from amplifier 12 with the input terminal 18 and resistor input 26. Circuit 20 is composed of resistors 36, 38 and capacitors 40, 42, 44. Circuit 20 acts as a filter and, at the same time, effects the matching of output signals from amplifier 12 with the terminal 18 and resistor input 26.

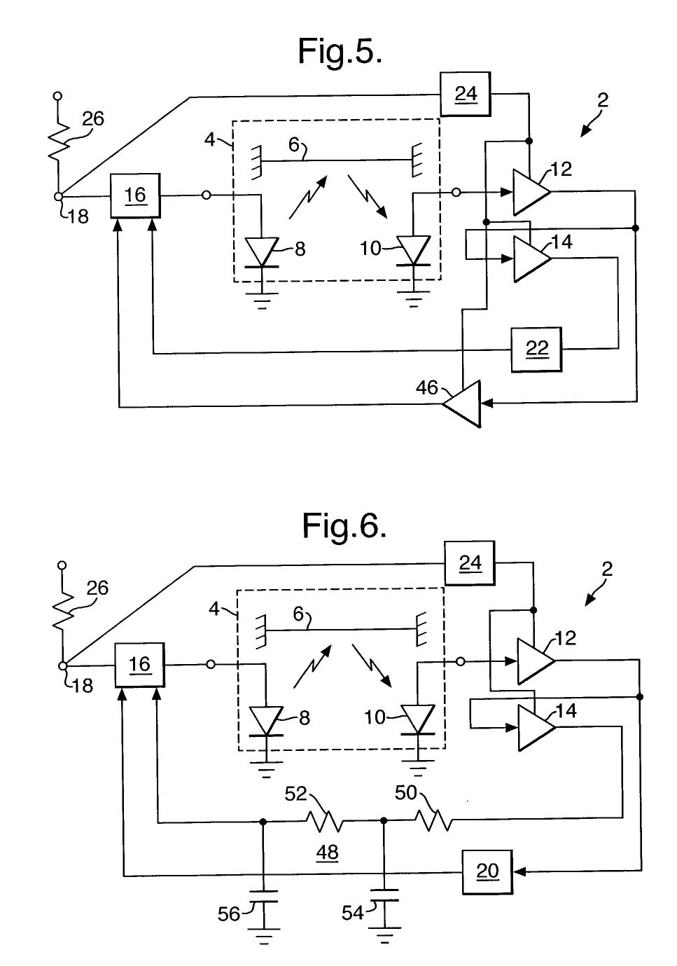

A further embodiment of the present invention is shown in FIG. 5. Here, the circuit 20 (FIG. 1) is replaced by an amplifier 46, the task of which is to amplify the output signal from amplifier 12 and match it with the input requirements of the resistor input 26. Contrary to the embodiment of FIG. 3, where the transistor 30 plays the role of an amplifier but may at the same time influence the light source 8, in the embodiment of FIG. 5, amplifier 46 does not influence the light source at all.

In FIG. 6, the circuit 22 (FIG. 1) is made as a filter 48, including resistors 50, 52 and capacitors 54, 56. Filter 48 is used for filtration and matching of the output signal from processing amplifier 14 with circuit 16. This embodiment is the simplest realization of circuit 22.

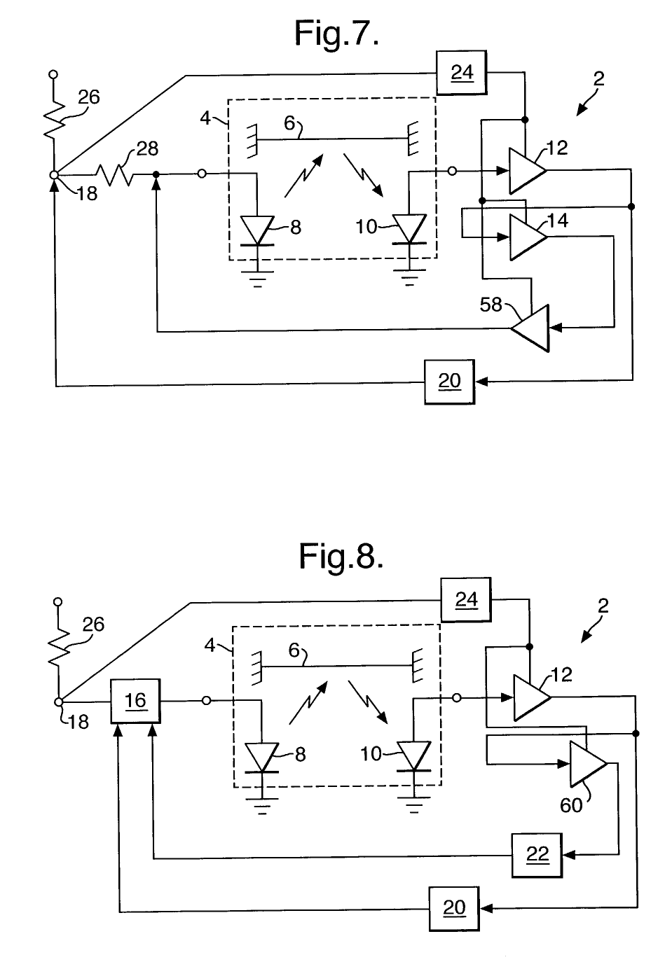

Referring now to FIG. 7, circuit 22 (FIG. 1) is constituted by an amplifier 58 that is used for amplification of the output signal from processing amplifier 14, filtering and matching it with circuit 16, embodied, e.g., by a resistor 28. This embodiment is especially effective when there is a need to suppress very strong acoustical noises, such as those made by trucks, planes, etc.

A still further embodiment is illustrated in FIG. 8. The processing amplifier 14 is made as a non-linear or logarithmic amplifier 60, possessing non-linear amplification for signals in different frequency and amplitude ranges. One possible use of such an amplifier is for performing linear amplification of small input signals and non-linear amplification of large input signals, e.g., signals over a pre-set level.

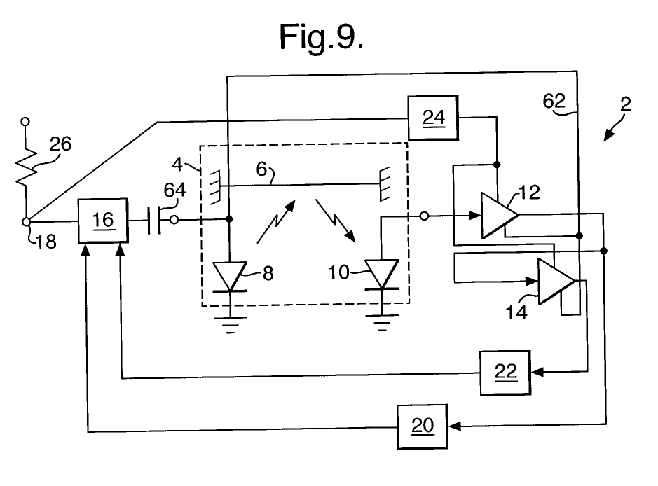

In the embodiment of FIG. 9, light source 8 is not fed directly from the DC current of resistor input 26, but from the current used by amplifiers 12 and 14. For this purpose, the ground contacts of these amplifiers are connected to light source 8 by lead 62, causing the output current of amplifiers 12, 14 to flow through light source 8. In this case, the current consumption of the optical microphone may be even less than it is in the previous embodiments. Capacitor 64 prevents the direct supply of current to the optical microphone from the resistor input 26 phantom power source from reaching light source 8; at the same time, it allows AC signals from circuit 22 to arrive at light source 8. In this embodiment, all other connections are the same as they are in the other embodiments. The current consumption of the embodiment of FIG. 9 is low, thus being useful in the event that the phantom power has a high voltage and low current.

In all of the embodiments described herein, the output signal of processing amplifiers 12 and 46, or 14 and 58, may be in phase or in opposite phase with the output signal of photodetector 10, depending on the specific construction of the amplifiers.

The operation of the noise suppression phantom power optical microphone system 2 will now be described with reference to FIG. 1. The output of phantom power noise suppression optical microphone system 2 is, at the same time, the input to a circuit to which it is connected, shown as the resistor input 26. A very small leakage current from the phantom power source input 26 is fed through circuit 16 to the light source 8 and through filter circuit 24 to amplifiers 12, 14. Light radiation produced by light source 8 illuminates membrane 6, which reflects it in the direction of photodetector 10. Sound pressures change the position of membrane 6, thereby modulating the reflected light intensity. As a result, the output signal of the photodetector is modulated also. Signal amplifier 12 amplifies the photodetector output signals which, after filtration and matching by circuit 20, reach the optical microphone output terminal 18. The output signal of amplifier 12 enters the input of processing amplifier 14 and, after passing through the filtering and matching circuit 22 and through circuit 16, arrives at light source 8.

Acoustic signals A and noise signals B produce a modulation of the light reflected by membrane 6 detected by photodetector 10 and amplified by amplifier 12. Processing amplifier 14 produces additional amplification of the signals A and B. Only noise signal B is still in the linear range of the output signal from amplifier 14; normal acoustical signal A saturates amplifier 14 and does not change its output signal. The output signal of amplifier 14 passes through circuits 22 and 16 as a negative feedback to light source 8.

In the range of noise signals, when the output signals are in the linear range of amplifier 14, the negative feedback signals that arrive at light source 8 modulate its light intensity and diminish the amplitude of the noise signals at the output of photodetector 10.

In the range of normal acoustical signals, amplifier 14 is in a saturation condition and its output signals do not produce negative feedback signals which return through circuits 22 and 16 to light source 8, and do not produce any negative feedback effects on the intensity of the light produced by light source 8.

Thus, all noise components of the light signals transmitted to photodetector 10 are compensated by the negative feedback light modulation of the light source 8, and hence, all noises at the output of the noise suppression phantom power light source system are diminished.

According to the embodiment of FIG. 3, where circuit 16 is realized by a transistor 30, the output signal of amplifier 12 through circuit 20 is fed to the base of transistor 30 and, after amplification by transistor 30, it then passes to the optical microphone output through the collector of the transistor. Signals from processing amplifier 14, through circuit 22, arrive directly at light source 8 via the emitter of transistor 30. The resistor 66, between the collector and the base of transistor 30, determines the feeding current of light source 8.

In all of the embodiments of FIGS. 1-9, the processing amplifier 14 may produce output signals in phase or out of phase, with the signals being produced by photodetector 10.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A noise suppression phantom power optical microphone system having an optical microphone consisting of a light source having an input terminal, a membrane and a photodetector having an output terminal, said system comprising:
a signal amplifier connectable to the output terminal of said photodetector;
a processing amplifier connected to the output of said signal amplifier for providing high amplification to relatively weak input signals and low amplification to relatively strong input signals;
a first circuit connecting the input terminal of said light source to a phantom power source;
a second circuit connecting the output of said signal amplifier to said first circuit, and
a third circuit connecting the output of said processing amplifier to said first circuit.

2. The noise suppression phantom power optical microphone system as claimed in claim 1, wherein said processing amplifier is a non-linear amplifier.

3. The noise suppression phantom power optical microphone system as claimed in claim 1, wherein the output signals of said processing amplifier are in phase with the output signals of said photodetector.

4. The noise suppression phantom power optical microphone system as claimed in claim 1, wherein the output signals of said processing amplifier are in opposite phase with the output signals of said photodetector.

5. The noise suppression phantom power optical microphone system as claimed in claim 1, wherein said light source is fed by current passing through said signal and/or processing amplifiers, and is connected to the output of said processing amplifier through a capacitor.

6. The noise suppression phantom power optical microphone system as claimed in claim 1, wherein said first circuit comprises at least one resistor.

7. The noise suppression phantom power optical microphone system as claimed in claim 1, wherein said first circuit comprises a transistor circuit.

8. The noise suppression phantom power optical microphone system as claimed in claim 1, wherein said second circuit comprises several resistors and capacitors arranged in a filter configuration.

9. The noise suppression phantom power optical microphone system as claimed in claim 1, wherein said second circuit comprises an amplifier.

10. The noise suppression phantom power optical microphone system as claimed in claim 1, wherein said third circuit comprises several resistors and capacitors arranged in a filter configuration.

11. The noise suppression phantom power optical microphone system as claimed in claim 1, wherein said third circuit comprises an amplifier.
